(19) United States
(12) Patent Application Publication
(10) Pub. No.: US 2024/0176383 A1
(43) Pub. Date: May 30, 2024

(54) Method of Producing and a Photonic Metasurface for Performing Computationally Intensive Mathematical Computations

(71) Applicants: Siemens Corporation, Washington, DC (US); THE TRUSTEES OF PRINCETON UNIVERSITY, Princeton, NJ (US); The Penn State University-College of Earth & Mineral Sciences, University Park, PA (US)

(72) Inventors: Heng Chi, Plainsboro, NJ (US); Huijuan Xu, Flowery Branch, GA (US); Alejandro Rodriguez, Princeton, NJ (US); Mohamed El Amine Houyou, Jersey City, NJ (US); Wesley Reinhart, Boalsburg, PA (US); Sean Molesky, Princeton, NJ (US); Pengning Chao, North Princeton, NJ (US)

(73) Assignees: Siemens Corporation, Washington, DC (US); THE TRUSTEES OF PRINCETON UNIVERSITY, PRINCETON, NJ (US); The Penn State University-College of Earth & Mineral Sciences, University Park, PA (US)

(21) Appl. No.: 18/549,477

(22) PCT Filed: Mar. 9, 2022
(86) PCT No.: PCT/US2022/019419

§ 371 Date: Sep. 7, 2023

Related U.S. Application Data
(60) Provisional application No. 63/160,016, filed on Mar. 12, 2021.

(51) Int. Cl. G06E 1/04; G02B 1/00; G02B 27/00

(52) U.S. Cl. CPC G06E 1/045; G02B 1/002; G02B 27/0012

(57) ABSTRACT

According to aspects of embodiments described herein, an optical computing device (100) comprises a plurality of input waveguides (101), a photonic meta-surface (103) in contact with the plurality of input waveguides, and a plurality of output waveguides (105) in contact with the transformational meta-surface. The optical computing device may be configured to perform a mathematical operation may be a matrix multiplication. A computer-implemented method (300) of designing an optical computing device includes a plurality of input waveguides, a photonic meta-surface, and a plurality of output waveguides, the method includes exciting each input waveguide one-by-one (303) and measuring the energy at the input region and the output region (305) to determine a contribution of the current input waveguide. The sum of contributions (307) of all input waveguides are compared to a target transformation (315) to determine a loss value used to update a set of design parameters (317).

### TECHNICAL FIELD

This application relates to optical computing. More particularly, this application relates to the design and use of photonic meta-surfaces.

### BACKGROUND

Rapid advances in new technologies, such as machine learning, artificial intelligence and big-data analytics require more computing power than ever before. However, central processing units (CPUs) and graphics processing units (GPUs) based on electronic computing hardwares and architecutures are facing performance ceilings as Moore's Law slows down drastically. Accordingly, there is a strong desire for alternative computing platforms to reestablish Moore's law.

Optical computing devices offer a promising solution due to their ultra-fast speed and ultra-low energy consumption characteristics compared to their electrical counterparts. By intelligently engineering scattering of light, light propagation and light-matter interaction, it is possible to create tailored optical computing devices that achieve computationally intensive mathematical operations. Such concepts have been explored from various perspectives, ranging from more classic Fourier optics to the more recent calculus metasurfaces designed using Green's functions.

Linear algebra is the foundation for computing in the digial domain. Thus, being able to perform linear algebra operations using metasurfaces is significant when considering optical computing. According to embodiments described herein, a Topology Optimization is proposed to engineer metasurfaces having a greatly reduced device footprint, achieved by exploiting scattering of light and light-matter interaction to perform any generic matrix multiplication.

Currently, there are several popular optical computing platforms:

### Optalysys: 4f Optical Correlator

The so-called “4-f” optical correlator uses lenses to perform a Fourier transformation and then convolve two signals in the spatial frequency domain. It requires 4 focal lengths of physical device footprint, which makes it quite bulky compared to the thin meta-surfaces we are designing here. In terms of accuracy, these devices are like conventional electronic computers, except for offering a 10 to 100× higher throughput for a handful of specialized problems.

### LightOn: Random Projections

Random projections offer potentially huge numbers of operations per cycle through the use of scattering phenomena through complex media. Thus, a single cycle may yield 10¹² MAC, but such throughput requires massive overhead in terms of both device footprint (on the order of one meter) and frequency, which is something like 100 Hz. Likewise, a lengthy calibration procedure must be undertaken for each sample. Therefore, this technology in its present state is likely to remain extremely specialized.

### LightMatter: Mach-Zehnder Interferometer (MZI)

The use of Mach-Zehnder interferometer (MZI) for computation relies on a network of phase shifters connected by waveguides which allows for MAC operations. Many MZI units can be compiled together to achieve sophisticated operations similar to the construction of analog electronics. Each unit is typically microns in size, so devices of appreciable complexity occupy a footprint similar to an electronic computer chip. The power consumption is as low as 3 W, substantially better than electronic computers, while offering 10⁶ MAC per cycle.

### Neuromorphic Computing

The electronic neuromorphic computer TrueNorth has a MAC rate of 2.5 kHz, requires 4.9 μm² per MAC, and provides 5 bits of precision. Photonic designs operate faster, up to 20 GHZ, but require 200 μm² per MAC (also offering about 5 bits of precision).

In summary, most of the existing optical computing platforms have the advantage of higher throughput compared to their electronic counterparts. However, they are still relatively bulky in size, making them less competitive from a device footprint perspective. Improved solutions are desired which provide the needed throughput within a reduced device footprint.

### SUMMARY

According to aspects of embodiments described herein, an optical computing device comprises a plurality of input waveguides, a photonic meta-surface in contact with the plurality of input waveguides, and a plurality of output waveguides in contact with the transformational meta-surface. The optical computing device may be configured to perform a mathematical operation including but not limited to a matrix multiplication The plurality of input waveguides may be configured to receive an electromagnetic (EM) signal where the power level of the EM signal at each input waveguide represents a numerical value of a vector used as an input to the optical computing device. In addition, a phase of the EM signal at a given input waveguide may be considered to represent a sign of the numerical value. According to some embodiments, the optical computing device having 8 input waveguides may include a photonic meta-surface with a thickness of about 3 μm, for 16 input waveguides, the thickness of the photonic meta-surface may be about 4 μm and for a device having 32 input waveguides the photonic meta-surface may have a thickness of about 12 μm.

In another embodiment, a computer-implemented method of designing an optical computing device having a plurality of input waveguides, a photonic meta-surface, and a plurality of output waveguides includes determining a target transformation for the optical computing device, performing a plurality of optimization steps for designing the photonic meta-surface, each step comprising exciting input waveguides one-by-one, measuring the energy at the input region and the output region to determine a contribution of the current input waveguide, summing the contributions of all input waveguides, comparing the summed contributions to the target transformation to determine a loss function value, and updating a set of design parameters based on the loss function value. The set of design parameters may be updated according to an optimization to minimize the loss function value. In some embodiments, the optimization may be performed based on a limited memory BFGS algorithm. In some embodiments determining the contribution of at least two of input waveguides may be calculated in parallel. According to an embodiment, the target transformation is defined as a mathematical operation. The mathematical operation may be a matrix multiplication by way of non-limiting example. According to an embodiment, the target transformation is scaled by a normalization factor to comply with constraints of physics.

In some embodiments, the loss function includes a term for enforcing a target electrical field at an input region of the optical computing device and a term for enforcing a target electrical field at an output region of the optical computing device, enforcing the target electrical field at the input region of the optical computer device reduces an effect of backscatter of an input electromagnetic (EM) signal at the input region of the optical computing device. To produce an optical computing device having an improved smaller footprint the photonic meta-surface may be designed to have a thickness of about 3 μm for an optical computing device having 8 input waveguide channels. For an optical computing device having 16 input waveguide channels the photonic meta-surface may be designed to have a thickness of about 4 μm while for an optical computing device having 32 input waveguide channels the photonic meta-surface may be designed to have a thickness of about 12 μm.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

### DETAILED DESCRIPTION

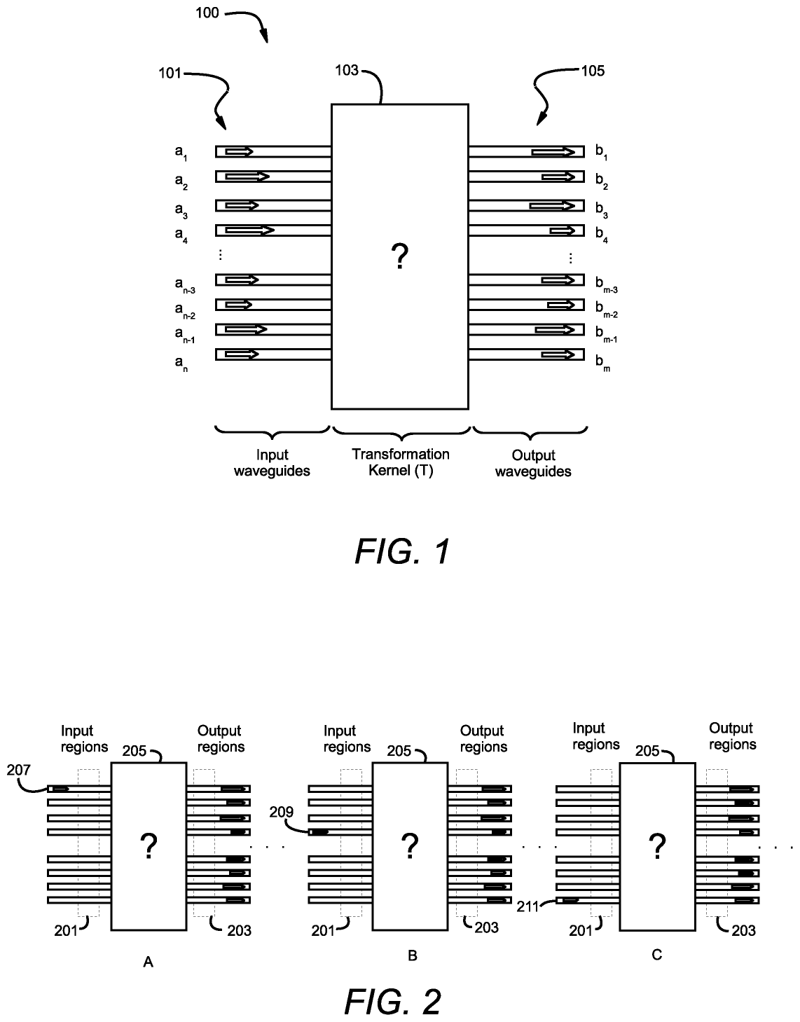

According to embodiments of this disclosure, an optical computing device 100 is provided as shown in FIG. 1. Optical computing device 100 comprises a plurality (n) of input waveguides a₁-aₙ 101. The input waveguides 101 are configured to receive an optical signal at each input waveguide. Additionally, there are a plurality (m) of output waveguides b₁-bₘ 105. Connected between input waveguides 101 and output waveguides 105 is a transformation kernel 103, which manipulates lights signals received at the input waveguides 101 and creates a set of light signals at each of the output waveguides 105. The optical computing device 100 may be programmed to perform transformation operations represented by a generic matrix T ∈ [symbol] ^{n×m}, such that b=Ta, where a=[a₁, . . . , aₙ]^{T} and b=[b₁, . . . , bₘ]^{T} are associated with the EM wave in the input waveguides 101 and output waveguides 105 respectively. The magnitudes of the components in vectors a and b are embodied in a power of the EM signal transmitted into each waveguide. Additionally, the signs of the vector components are represented by a relative phase between waveguides 101, 105. That is, if a first EM signal in a given waveguide is regarded as “positive”, any waveguides that contain EM signals that are in phase with the first signal are considered to represent positive values, while those waveguides containing EM signals that are out of phase with the first signal are considered to represent negative values.

The transformation kernel 103 comprises an optical meta-surface which controls the propagation of a lights signal from the input waveguides 101 to the output waveguides 105. The optical meta-surface of the transformation kernel 103 may be select to produce a set of values representative of components forming a vector. Thus, for a given operation or transformation, a set of values may be encoded as an EM signal to the input waveguides 101 and the transformation kernel 103 is selected such that a pre-determined set of output values are produced at the output waveguides 105.

According to certain embodiments of this disclosure, the transformation kernel 103 may be designed using an inverse design formulation. The details of the inverse design of an optical computing device like that shown in FIG. 1 will now be described.

As discussed above, the transformation kernel 103 comprises a photonic meta-surface that directs and scatters light provided as an optical input signal. The topology of the optical meta-surface will determine the light transmitting properties of the photonic meta-surface. By controlling this topology, the characteristics of the transformation kernel 103 may be designed to perform a desired function. According to one embodiment of this disclosure, a proposed topology optimization to design the new computing device may be presented as:

$${min}_{ρ} ℒ ( ε ( ρ ) ) \\ s . t . Maxwell Equation \qquad Equation ( 1 )$$

where ρ is the design variable vector, ε is the dielectric permittivity distribution interpolated from the design variable ρ, and the loss function [symbol] (⋅) has the specific form of:

$$ℒ ( ε ( ρ ) ) = \frac{w}{n} {\sum }_{n = 1}^{n} ‖ {𝕀}_{in} ( {E}_{z} ( ε ( ρ ) ) ) - {F}_{i}^{in} ( x ) ‖ + \frac{1 - w}{n} {\sum }_{n = 1}^{n} ‖ {𝕀}_{out} ( {E}_{z} ( ε ( ρ ) ) ) - {F}_{i}^{out} ( x ) ‖ , \qquad Equation ( 2 )$$

where [symbol] ᵢₙ and [symbol] ₒᵤₜ are the extraction operators which extract the electrical field E_{z} at the input and output regions, respectively,
Fᵢⁱⁿ(x) and Fᵢ^{out}(x) are the target EM fields needed to enforce in the input and output regions when the ith input waveguide is excited by a unit excitation, respectively,
n is the number of input waveguides, and w is a weighting factor selectable by a user for favoring the physical phenomenon of backscatter, where light enters the input waveguides and is reflected back through the input region, and output energy directed to generating the desired transformation output.

Enforcing the target field Fᵢⁱⁿ(x) in the input region minimizes the backscatter of input EM wave and enforcing the target field Fᵢ^{out}(x) makes sure that the target transformation is achieved. Fᵢ^{out}(x) needs to be calculated before performing topology optimization from the target transformation matrix T, which encodes the information of the ith column of matrix T.

FIG. 2 provides an illustration of an inverse design optimization for determining a topology for the optical meta-surface of an optical calculating device according to embodiments of this disclosure. For each input waveguide in the input region 201, one of the plurality of input waveguides is excited while all other input waveguides are kept unexcited. At each step of the optimization, each input waveguide is excited one by one until all input waveguides have been excited. At each excitation, the associated EM fields Fᵢⁱⁿ(x) and Fᵢ^{out}(x) are computed based on a target matrix T. The fitting loss attributable to each input waveguide is summed according to the loss function in Equation (2) above. Referring to FIG. 2, scenario A shows the excitation of the first input waveguide a₁ 207. The application of the EM signal to waveguide a₁ causes the light from the EM signal to scatter throughout the optical meta-surface of design scenario 205 and produce output signals at each of the output waveguides in the output region 203. This optimization is performed on a computer performing a simulation of the optical computing device. In a second simulations step shown in scenario B, the fourth input waveguide 209 is excited while holding all other input waveguides unexcited. The application of the EM signal to the fourth waveguide 209 causes light from the EM signal to scatter throughout the optical meta-surface simulated as design scenario 205. This process of applying the EM signal to one input waveguide at a time until the last input waveguide 211 is excited while holding all other input waveguides unexcited. This provides output values and the output waveguides at the output region 203 based on the last waveguide 211. Each individual waveguide channel on the input side is excited. In particular, at each topology optimization step each individual waveguide channel is excited by a unit excitation (while keeping the others unexcited). Then the associated EM fields Fᵢⁱⁿ(x) and Fᵢ^{out}(x) are computed based on a target matrix T. The fitting loss contribution from each input waveguide are summed to obtain the loss function defined above in Equation (2). The exact gradient of the loss function is computed using the automatic differentiation and the design variables ρ are updated via an optimization. In one embodiment, a Limited Memory BFGS algorithm may be used to update the design variables. This procedure is then repeated until convergence of the design variables is achieved. The design variables ρ reference design points in the optical meta-surface. The volume of the optical meta-surface may be viewed as voxels within the volume. Each voxel may be assigned a binary value, by way of example. A first binary value represents material present at the voxel, while a second binary value represents an absence of material at the voxel. Once the optimized design is obtained, according to the principle of superposition, it is able to achieve the target transformation matrix T for any generic input vector.

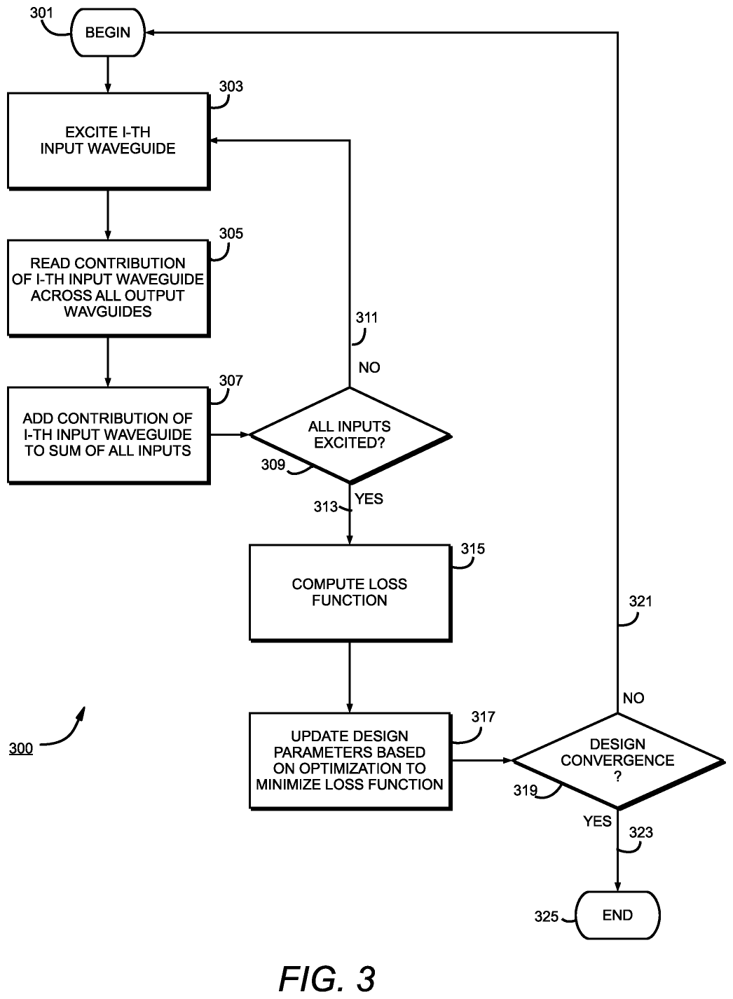

FIG. 3 is a process flow diagram for optimizing a topology of an optical computing meta-surface according to aspects of embodiments of this disclosure. A method 300 for optimizing an optical meta-surface. An optimization step starts 301 by applying a unit excitation to one of a plurality of input waveguides while holding all other input waveguides in an unexcited state 303. With the selected input waveguide excited, the input EM signal is transmitted through a simulated optical metasurface, to produce simulated outputs at a plurality of output waveguides. The simulated outputs represent the contribution of the selected (i^{th}) input waveguide and are read to capture the contribution of the selected input waveguide to the fitting loss used to evaluate and optimize the current design of the optical computing device 305. The plurality of input waveguides will be evaluated through excitation one-by-one to identify the fitting loss contribution of each input waveguide. As each input waveguide is evaluated it's contribution is added to a running sum for the overall design 307. Next, it is determined if all input waveguides have been evaluated in the current optimization step 309. If no 311, then the next input waveguide is excited while holding all other input waveguides unexcited 303.

If all input waveguides have been excited in the current optimization step 313, then the loss function of Equation (2) is computed to determine how close the current design alternative comes to producing an output consistent with a target transformation. Seeking to minimize the loss function, an optimization step may be performed to produce an updated set of design parameters. The design parameters represent physical aspects of the optical meta-surface and control the propagation of light through through the optical meta-surface and consequently, the output levels at the output waveguides. Based on the computed loss function, the design parameters are updated through optimization to minimize the loss function 317. The results of analysis on the updated design parameters are monitored after each optimization step. The updated design parameters are then check for convergence 319. If the design parameters have converged 323, the topology optimization ends 325. The the design parameters have not converged 321, a next topology optimization step 301 is performed.

With respect to the inverse design workflow described above, the associated computational cost scales linearly with the total number of input waveguides n as the number of columns of the target transformation matrix T. However, the implementation may easily be parallelized such that the computation on each individual waveguide is done in parallel, leading to significant improvements in the efficiency of the inverse design process.

Here, we provide an illustrative example to further demonstrate how the inverse design is implemented. In this illustrative example, we consider a 2 by 2 matrix T as:

$$T = [ \begin{matrix}0.2773501 & - 0.5547002 \\ - 0.5547002 & 0.8320502\end{matrix} ] \qquad Equation ( 3 )$$

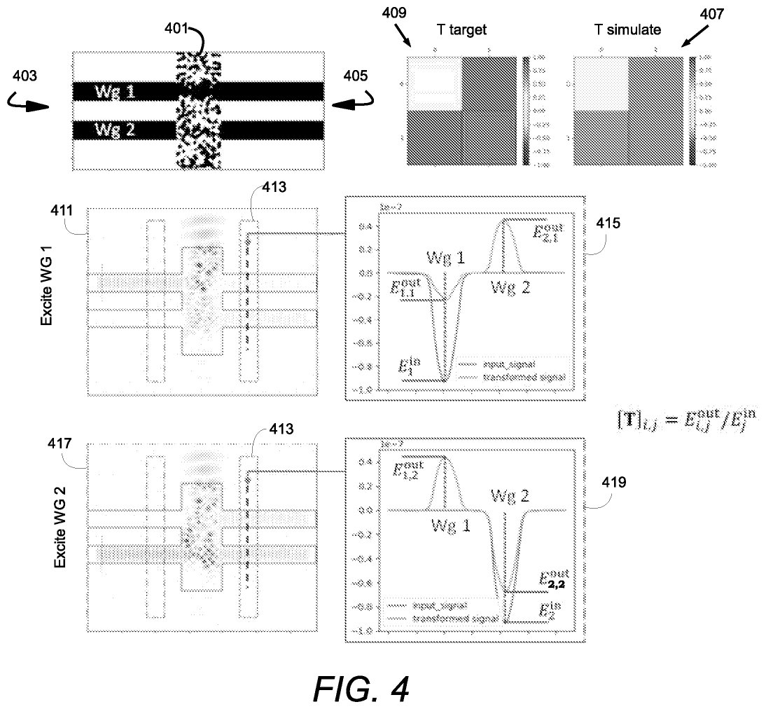

FIG. 4 is an illustration of a topology of an optimized meta-surface 401 with 2 input waveguides 403 and two output waveguides 405, the simulated 407 versus target transformation 409 matrices, and the procedure to determine the actual transformation matrix based on EM simulations. As waveguide 1 is excited 411, the energy field in the output region 413 is captured 415. Next, waveguide 2 is excited 417 and the output field at the output region 413 is captured 419. The captured output fields of each input waveguide are summed to produce the simulated results 407. The simulated results 407 are compared to the target 409. The design parameters of the photonic meta-surface 401 are updated and another optimization step is performed in an attempt to minimize a difference between the simulated results 407 and the target result 409.

### Matrix Normalization

A generic transformation matrix may take any values in its components. However, a physical meta-surface must satisfy constraints imposed by physics laws. In practice a meta-surface cannot physically represent a matrix with any magnitudes as the meta-surface cannot generate energy from nothing. As a result, the target matrix 309 must be scaled by a normalization factor before it can be encoded into a physical device using an inverse design procedure.

It may be assumed that the inverse design procedure generates a meta-surface with 0 fitting error. If the set of input wave guides are excited with an arbitrary input vector a, the energy levels at the output waveguides will be vector Ta. The total input energy (summing up the energy associated with each input waveguide) equals:

$$E {n}_{i n} = \frac{1}{2} {a}^{T} a , \qquad Equation ( 4 )$$

while the total output energy(summing up the energy associated with each output waveguide) equals:

$$E {n}_{out} = \frac{{s}^{2}}{2} {a}^{T} {T}^{T} Ta , \qquad Equation ( 5 )$$

where s is the normalization factor derived from this analysis.

Energy cannot be spontaneously created. Accordingly, Enᵢₙ≥Enₒᵤₜ for any choice of a, leading to the following condition:

a^{T}(I−s²T^{T}T)a≥0 Equation (6)
for any real-valued input vector a.

Let us consider the singular value decomposition (SVD) of T=UΣV^{T}, U and V are unitary (rotational) matrices and Σ is a diagonal matrix containing the singular values of T. The SVD of T may be applied to the above condition, which gives:

a^{T}(I−s²VΣ²V^{T})a≥0 Equation (7)
for any real-valued input vector a. We can show that if we take s as the inverse of the maximum absolute value of |Σ|, which corresponds to the singular value of T with the largest absolute value, the above condition will always be satisfied, and the energy conservation is ensured for any input signal.

### A Design Example

As a demonstrating example, we consider the Laplacian of Gaussian operator T_{LoG}. The 1D Laplacian of Gaussian operator is given as the composition of a Laplacian operator with a Gaussian operator: T_{LoG}=T_{L}T_{G}, where T_{L} is the matrix representation of the Laplacian operator and T_{G} is the matrix representation of the Gaussian smoothing operator.

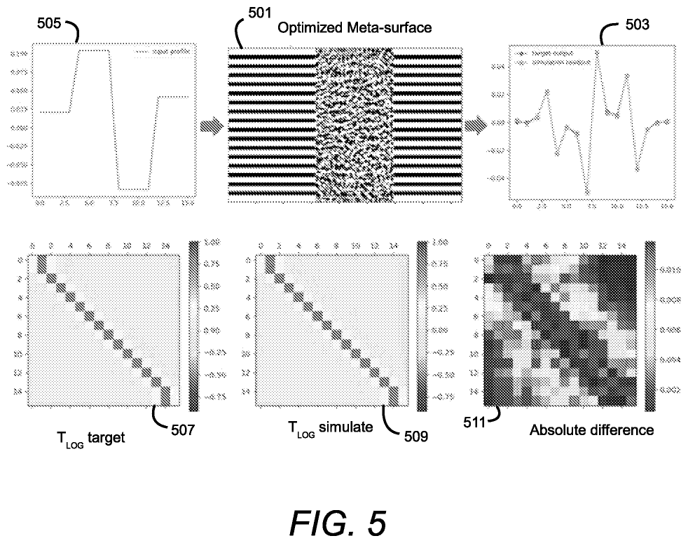

Referring to FIG. 5, a design case 501 with 16 waveguide channels on both input and output sides is considered. The dimensions of the design domain are set as 4λ×8λ, where the first dimension is the thickness of the meta-surface, the second dimension is the height of the meta-surface, and λ=1000 nm is the wavelength of the input wave in the free space. The width of each individual waveguide is λ/5, which allows the propagation of only a first transverse EM (TEM) mode.

FIG. 5 shows the final meta-surface configuration obtained from the inverse design. Once the meta-surface 501 is obtained from the inverse design, frequency domain EM simulation is performed on the meta-surface 501 and calculates the transformation encoded into the meta-surface (i.e., simulating the reading process). Input signal 505 is applied to the simulated meta-surface to generate the simulated transformation output 503. The comparison of the simulated transformation with the target transformation T_{LoG} is shown in graph 503. The absolute differences 511 in each component of the simulated 509 and target 507 transformations are also provided. As may be seen from the comparisons, the inverse designed meta-surface 501 achieves the target transformation 507 with good accuracy (i.e., maximum error being ˜1%).

In addition, to demonstrate the full functionality of the optimized meta-surface, consider a randomly chosen input signals 505 as shown in FIG. 5. We perform EM simulations to the meta-surface 501 with the by exciting each input waveguide channel according to the profile of the generated input signal 505, record the magnitudes as well as phases in the output waveguides 503, and convert them into the vectors of both systems. The comparisons of the simulated output vector 509 and the target output vector 507 (computed analytically) is shown. Excellent correlation of the simulation results to the target output is observed 511.

Using the inverse design workflow proposed in this disclosure, any desirable real-valued matrix multiplication may be very accurately encoded into a miniaturized photonic meta-surface. In comparison to state-of-the-art optical computing platforms such as the MZI, the photonic meta-surface obtained from the inverse design formulation of this disclosure possesses the unique advantage of a significantly reduced device footprint (up to an order of magnitude reduction in size while achieving the same computing task based on estimation). This is fundamentally because the inverse-designed meta-surface achieves a target transformation by a many-to-many coupling of input to output waveguide channels instead of pairwise coupling, as used in the MZI.

A potential application with great promise is utilizing the inverse-designed photonic meta-surface computing device to realize a fully optical neural network. The proposed inverse design may realize any matrix multiplication into photonic meta-surface. In addition, with the help of input output waveguide channels, the resulting optical computing device is highly modular and can be easily coupled to other photonic meta-surface computing devices via the input waveguides and output waveguides. This creates the possibility of encoding a fully trained neural network into a network of photonic meta-surfaces (with the incorporation of nonlinear optical devices, which in principle can also be inverse designed). The advantage is that the realized optical neural network can easily perform instant (with the speed of light) predictions with a minimum amount of energy consumption. This makes them extremely attractive for applications that require real-time prediction and control, such as vowel identification, image detection and decision making in autonomous driving environments.

### A quantitative Comparison of the Device Footprint to the MZI

The existing optical computing platform, which shares the most similarity in term of functionality (i.e., to perform matrix operation) with the one proposed in this IDF is the MZI. However, initial analysis suggest that the inverse designed metasurface is able to achieve the same functionality as the MZI, but with a significantly reduced device footprint due to its many-to-many coupling nature.

More specifically, the MZIs require pairwise coupling between input channels rather than all-toall. If the matrix T is a unitary (i.e., all the singular value being 1) one, performing the transformation T requires spread out the information over a large domain and use waveguides to direct the optical flow between the different channels. The number of 2 by 2 couplers required for N channels is

$$M = \frac{N !}{2 ( N - 2 ) !} .$$

This grows rapidly with the number of channels: 28 for 8 channels, 120 for 16 channels, 496 for 32 channels, 2016 for 64 channels. With optimal packing, the footprint grows linearly with the number of channels in both transverse and propagation directions. Each MZI may be 10 by 100 μm in size, so a device with 32 channels will require on the order of 0.32-3.2 mm on each side.

This gets even worse when we consider a non-unitary T, where its SVD has to be performed to realize it. In this case we have to implement two unitary operators, V^{T} and U, in addition to the scaling from singular values Σ. This is necessary because the interferometers don't leak any significant amount of power so there is no way to scale down the signal inside the MZI mesh. Thus for a non-unitary operator the device requires a little more than double the footprint in the propagation direction.

Conversely, our device, designed via topology optimization, can be implemented with waveguides only 0.5 μm per channel in the transverse direction (the wavelength λ is consider to be 1 μm). We have not identified a rigorous scaling rule to determine how much material is required in the propagation direction, but we have found that 3 μm works for 8 channel, 4 μm works for 16 channel, and 12 μm works for 32 channels, the latter of which presents a least an order of magnitude reduction in footprint as compared to the MZI. This suggest significant advantage of the proposed metasurface in footprint over the MZI architecture.

### Comparison With a Recent Work for Photonic Metasurface Inverse Design

Recent work by Qu, Y, et al., “Inverse Design of an Integrated-nonophotonics Optical Neural Network”, Science Bulletin, 65(14), pp. 1177-1183 introduced an inverse design formulation to design optical scattering units using input and output waveguide channels, aiming for optical neural network applications. The inverse design approach and formulation proposed in this disclosure takes a different approach with a different concept, and is more general in terms of capability. In particular, the other work considers only the intensity of signals in the waveguide channels to encode matrix operators, whereas the inverse design formulation introduced in this disclosure exploits both intensity and phase information of the signals in the waveguide channels to encode a generic matrix transformation. Morover, the inverse design procedure is different as well, namely, the formulation in the prior work requires excitation all input waveguide together in a coupled manner whereas embodiments of this disclosure excites each input waveguide one by one in a decoupled way. As a result, the inverse design formulation introduced in prior work can only encode unitary matrics (i.e., rotation matrics which satify T^{T}T=I), while the inverse design formulation can encode any real-valued matrix (even those with more than one values of singular values). In addition, the proposed inverse design framework appears to have better scaling performance as compared to the prior work. In embodiments of this disclosure a device may be achieved having 50 input and output waveguide channels, whereas the largest one achieved in prior work contained only 9 input and output waveguide channels.

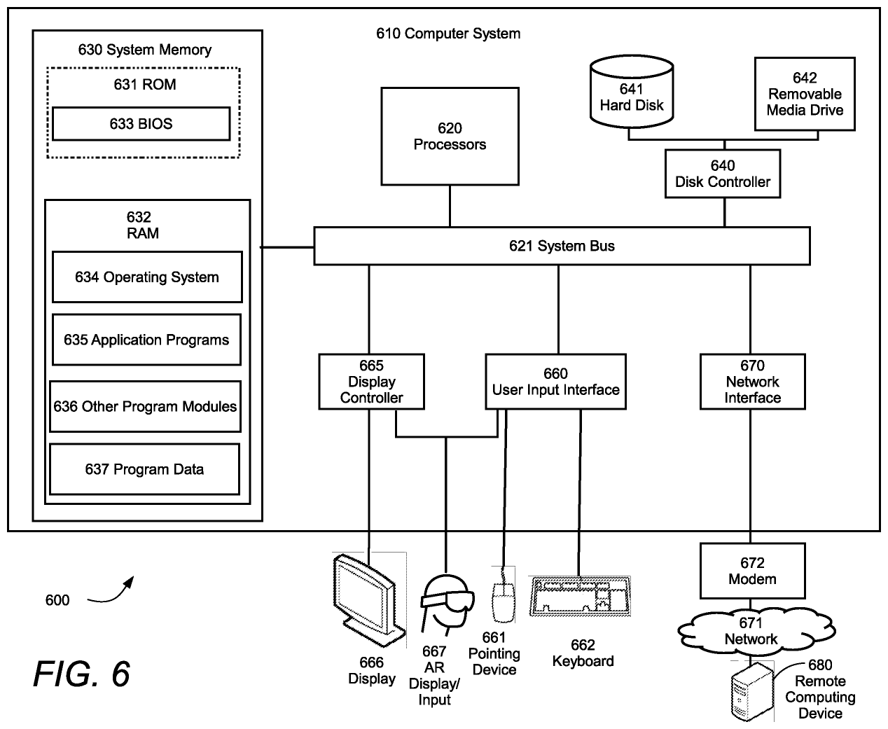

FIG. 6 illustrates an exemplary computing environment 600 within which embodiments of the invention may be implemented. Computers and computing environments, such as computer system 610 and computing environment 600, are known to those of skill in the art and thus are described briefly here.

As shown in FIG. 6, the computer system 610 may include a communication mechanism such as a system bus 621 or other communication mechanism for communicating information within the computer system 610. The computer system 610 further includes one or more processors 620 coupled with the system bus 621 for processing the information.

The processors 620 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting, or transmitting information for use by an executable procedure or an information device, and/or by routing the information to an output device. A processor may use or comprise the capabilities of a computer, controller, or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 6, the computer system 610 also includes a system memory 630 coupled to the system bus 621 for storing information and instructions to be executed by processors 620. The system memory 630 may include computer readable storage media in the form of volatile and/or nonvolatile memory, such as read only memory (ROM) 631 and/or random-access memory (RAM) 632. The RAM 632 may include other dynamic storage device(s) (e.g., dynamic RAM, static RAM, and synchronous DRAM). The ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system 633 (BIOS) containing the basic routines that help to transfer information between elements within computer system 610, such as during start-up, may be stored in the ROM 631. RAM 632 may contain data and/or program modules that are immediately accessible to and/or presently being operated on by the processors 620. System memory 630 may additionally include, for example, operating system 634, application programs 635, other program modules 636 and program data 637.

The computer system 610 also includes a disk controller 640 coupled to the system bus 621 to control one or more storage devices for storing information and instructions, such as a magnetic hard disk 641 and a removable media drive 642 (e.g., floppy disk drive, compact disc drive, tape drive, and/or solid-state drive). Storage devices may be added to the computer system 610 using an appropriate device interface (e.g., a small computer system interface (SCSI), integrated device electronics (IDE), Universal Serial Bus (USB), or FireWire).

The computer system 610 may also include a display controller 665 coupled to the system bus 621 to control a display or monitor 666, such as a cathode ray tube (CRT) or liquid crystal display (LCD), for displaying information to a computer user. The computer system includes an input interface 660 and one or more input devices, such as a keyboard 662 and a pointing device 661, for interacting with a computer user and providing information to the processors 620. The pointing device 661, for example, may be a mouse, a light pen, a trackball, or a pointing stick for communicating direction information and command selections to the processors 620 and for controlling cursor movement on the display 666. The display 666 may provide a touch screen interface which allows input to supplement or replace the communication of direction information and command selections by the pointing device 661. In some embodiments, an augmented reality device 667 that is wearable by a user, may provide input/output functionality allowing a user to interact with both a physical and virtual world. The augmented reality device 667 is in communication with the display controller 665 and the user input interface 660 allowing a user to interact with virtual items generated in the augmented reality device 667 by the display controller 665. The user may also provide gestures that are detected by the augmented reality device 667 and transmitted to the user input interface 660 as input signals.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium, such as a magnetic hard disk 641 or a removable media drive 642. The magnetic hard disk 641 may contain one or more datastores and data files used by embodiments of the present invention. Datastore contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processors 620 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 641 or removable media drive 642. Non-limiting examples of volatile media include dynamic memory, such as system memory 630. Non-limiting examples of transmission media include coaxial cables, copper wire, and fiber optics, including the wires that make up the system bus 621. Transmission media may also take the form of acoustic or light waves, such as those generated during radio wave and infrared data communications.

The computing environment 600 may further include the computer system 610 operating in a networked environment using logical connections to one or more remote computers, such as remote computing device 680. Remote computing device 680 may be a personal computer (laptop or desktop), a mobile device, a server, a router, a network PC, a peer device, or other common network node, and typically includes many or all of the elements described above relative to computer system 610. When used in a networking environment, computer system 610 may include modem 672 for establishing communications over a network 671, such as the Internet. Modem 672 may be connected to system bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computing device 680). The network 671 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite, or any other wireless connection methodology generally known in the art. Additionally, several networks may work alone or in communication with each other to facilitate communication in the network 671.

An executable application, as used herein, comprises code or machine-readable instructions for conditioning the processor to implement predetermined functions, such as those of an operating system, a context data acquisition system or other information processing system, for example, in response to user command or input. An executable procedure is a segment of code or machine-readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers, and processes can be implemented using hardware components, software components, and/or combinations thereof. No claim element herein is to be construed under the provisions of 35 U.S.C. 112, sixth paragraph, unless the element is expressly recited using the phrase “means for.”

What is claimed is:

1. An optical computing device comprising:
a plurality of input waveguides;
a photonic meta-surface in contact with the plurality of input waveguides; and
a plurality of output waveguides in contact with the transformational meta-surface.

2. The optical computing device of claim 1, wherein the optical computing device is configured to perform a mathematical operation.

3. The optical computing device of claim 2, wherein the mathematical operation is a matrix multiplication.

4. The optical computing device of claim 1, wherein the plurality of input waveguides are configured to receive an electromagnetic (EM) signal and the power level of the EM signal at each input waveguide represent a numerical value of a vector.

5. The optical computing device of claim 4, wherein a phase of the EM signal at a given input waveguide represents a sign of the numerical value.

6. The optical computing device of claim 1, wherein the number of input waveguides is 8, and a thickness of the photonic meta-surface is about 3 μm.

7. The optical computing device of claim 1, wherein the number of input waveguides is 16 and a thickness of the photonic meta-surface is about 4 μm.

8. The optical computing device of claim 1, wherein the number of input waveguides is 32 and a thickness of the photonic meta-surface is about 12 μm.

9. A computer-implemented method of designing an optical computing device having a plurality of input waveguides, a photonic meta-surface, and a plurality of output waveguides, the method comprising:
determining a target transformation for the optical computing device;
performing a plurality of optimization steps for designing the photonic meta-surface, each step comprising:
exciting input waveguides one-by-one;
measuring the energy at the input region and the output region to determine a contribution of the current input waveguide;
summing the contributions of all input waveguides;
comparing the summed contributions to the target transformation to determine a loss function value; and
updating a set of design parameters based on the loss function value.

10. The computer-implemented method of claim 9, further comprising:
updating the set of design parameters according to an optimization to minimize the loss function value.

11. The computer-implemented method of claim 10, wherein the optimization is performed based on a limited memory BFGS algorithm.

12. The computer-implemented method of claim 9, wherein determining the contribution of at least two of input waveguides is calculated in parallel.

13. The computer-implemented method of claim 9, further comprising:
defining the target transformation as a mathematical operation.

14. The computer-implemented method of claim 13, wherein the mathematical operation is a matrix multiplication.

15. The computer-implemented method of claim 14, wherein the target transformation is scaled by a normalization factor.

16. The computer-implemented method of claim 9, wherein the loss function includes a term for enforcing a target electrical field at an input region of the optical computing device and a term for enforcing a target electrical field at an output region of the optical computing device.

17. The computer-implemented method of claim 16, wherein the term for enforcing the target electrical field at the input region of the optical computer device reduces an effect of backscatter of an input electromagnetic (EM) signal at the input region of the optical computing device.

18. The computer implemented method of claim 9, further comprising:
designing the photonic meta-surface to have a thickness of about 3 μm for an optical computing device having 8 input waveguide channels.

19. The computer implemented method of claim 9, further comprising:
designing the photonic meta-surface to have a thickness of about 4 μm for an optical computing device having 16 input waveguide channels.

20. The computer implemented method of claim 9, further comprising:
designing the photonic meta-surface to have a thickness of about 12 μm for an optical computing device having 32 input waveguide channels.
